(19) United States
(12) Patent Application Publication
(10) Pub. No.: US 2025/0150233 A1
(43) Pub. Date: May 8, 2025

(54) METHOD AND APPARATUS FOR HANDLING VALIDITY OF CSI-RS OR TRS CONFIGURATION IN A WIRELESS COMMUNICATION SYSTEM

(71) Applicant: LG ELECTRONICS INC., Seoul (KR)

(72) Inventors: Sangwon KIM, Seoul (KR); Sunghoon JUNG, Seoul (KR); Seunggye HWANG, Seoul (KR)

(73) Assignee: LG ELECTRONICS INC., Seoul (KR)

(21) Appl. No.: 18/723,170

(22) PCT Filed: Feb. 6, 2023
(86) PCT No.: PCT/KR2023/001652

§ 371 Date: Jun. 21, 2024

(30) Foreign Application Priority Data
Feb. 9, 2022 (KR) 10-2022-0016918

(51) Int. Cl. H04L 5/00; H04W 56/00; H04W 72/232

(52) U.S. Cl. CPC H04L 5/0051; H04W 56/001; H04W 72/232

(57) ABSTRACT

A method and apparatus for handling the validity of the CSI-RS/TRS configuration in a wireless communication system is provided. The method comprises: receiving system information including a CSI-RS and/or TRS configuration; applying the CSI-RS and/or TRS configuration; receiving a system information change indication within a first modification period; considering that the CSI-RS and/or TRS configuration is invalid from a start of a second modification period; and performing synchronization based on at least one SSB.

### CROSS-REFERENCE TO RELATED APPLICATION(S)

This application is the National Stage filing under 35 U.S.C. 371 of International Application No. PCT/KR2023/001652, filed on Feb. 6, 2023, which claims the benefit of earlier filing date and right of priority to Korean Application No. 10-2022-0016918, filed on Feb. 9, 2022, the contents of which are all hereby incorporated by reference herein in their entireties.

### TECHNICAL FIELD

The present disclosure relates to a method and apparatus for handling the validity of the CSI-RS/TRS configuration in a wireless communication system.

### BACKGROUND

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

### SUMMARY

If UE receives the system information change indication within a modification period, the UE applies the SI acquisition procedure from the start of the next modification period. The UE applies the previously acquired system information until the UE acquires the new system information.

When UE wakes up to receive the updated system information in the next modification period, the UE can use the CSI-RS/TRS for time/frequency synchronization. However, if the system information which triggers the SI change indication is system information including the CSI-RS/TRS configuration, that is, if the system information including the CSI-RS/TRS configuration is updated, the UE would try to synchronize using the outdated CSI-RS/TRS configuration and may fail to receive the updated system information.

In other words, in NR, synchronization using Channel State Information Reference Signal (CSI-RS) and/or Tracking Reference Signal (TRS) is proposed. For example, CSI-RS/TRS configuration may be included in a specific system information block (SIB).

The SI change indication is not for a certain SIB. The SI change indication may inform that any SIB is changed. That is, it is not possible to know whether the specific SIB including the CSI-RS/TRS configuration is changed only by the SI change indication.

When the SI change indication is for the specific SIB including the CSI-RS/TRS configuration, and when the CSI-RS/TRS configuration is changed, the synchronization failure could occur since the UE could not know the updated CSI-RS/TRS configuration.

Therefore, studies for handling the validity of the CSI-RS/TRS configuration in a wireless communication system are required.

In an aspect, a method performed by a wireless device in a wireless communication system is provided. The method comprises: receiving system information including a Channel State Information Reference Signal (CSI-RS) and/or Tracking Reference Signal (TRS) configuration; applying the CSI-RS and/or TRS configuration; receiving a system information change indication within a first modification period; considering that the CSI-RS and/or TRS configuration is invalid from a start of a second modification period; and performing synchronization based on at least one Synchronization Signal and Physical Broadcast CHannel (PBCH) block (SSB).

In another aspect, an apparatus for implementing the above method is provided.

The present disclosure can have various advantageous effects.

According to some embodiments of the present disclosure, a wireless device could efficiently handle the validity of the CSI-RS/TRS configuration.

For example, after receiving the system information change indication, a wireless device can successfully receive the updated system information by stopping using the potentially outdated CSI-RS/TRS configuration.

In other words, for example, upon receiving a system information change indication within a modification period, a wireless device could consider the CSI-RS/TRS configuration is invalid from the start of the next modification period. In this case, the wireless device may not perform the synchronization based on the CSI-RS/TRS configuration during in the next modification period. Thus, the wireless device could avoid to perform the synchronization using the outdated CSI-RS/TRS configuration. In addition, the resources can be saved by preventing synchronization failure using the outdated CSI-RS/TRS configuration.

According to some embodiments of the present disclosure, a wireless communication system could provide an efficient solution for handle the validity of the CSI-RS/TRS configuration.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of a wireless device to which implementations of the present disclosure is applied.

FIG. 4 shows another example of wireless devices to which implementations of the present disclosure is applied.

FIG. 5 shows an example of UE to which implementations of the present disclosure is applied.

FIGS. 6 and 7 show an example of protocol stacks in a 3GPP based wireless communication system to which implementations of the present disclosure is applied.

FIG. 8 shows a frame structure in a 3GPP based wireless communication system to which implementations of the present disclosure is applied.

FIG. 9 shows a data flow example in the 3GPP NR system to which implementations of the present disclosure is applied.

FIG. 10 shows an example of a method for handling the validity of the CSI-RS/TRS configuration in a wireless communication system, according to some embodiments of the present disclosure.

FIG. 11 shows an example of handling the validity of the CSI-RS/TRS configuration.

FIG. 12 shows an example of applying the CSI-RS/TRS availability indication.

FIG. 13 shows an example of a synchronization signal and PBCH block.

### DETAILED DESCRIPTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE.

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

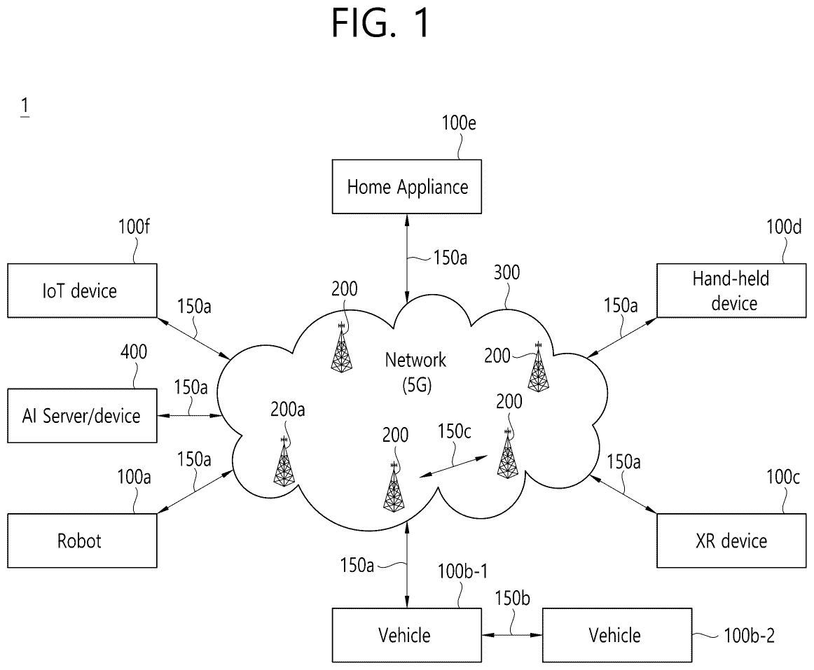

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Partial use cases may require a plurality of categories for optimization and other use cases may focus only upon one key performance indicator (KPI). 5G supports such various use cases using a flexible and reliable method.

eMBB far surpasses basic mobile Internet access and covers abundant bidirectional work and media and entertainment applications in cloud and augmented reality. Data is one of 5G core motive forces and, in a 5G era, a dedicated voice service may not be provided for the first time. In 5G, it is expected that voice will be simply processed as an application program using data connection provided by a communication system. Main causes for increased traffic volume are due to an increase in the size of content and an increase in the number of applications requiring high data transmission rate. A streaming service (of audio and video), conversational video, and mobile Internet access will be more widely used as more devices are connected to the Internet. These many application programs require connectivity of an always turned-on state in order to push real-time information and alarm for users. Cloud storage and applications are rapidly increasing in a mobile communication platform and may be applied to both work and entertainment. The cloud storage is a special use case which accelerates growth of uplink data transmission rate. 5G is also used for remote work of cloud. When a tactile interface is used, 5G demands much lower end-to-end latency to maintain user good experience. Entertainment, for example, cloud gaming and video streaming, is another core element which increases demand for mobile broadband capability. Entertainment is essential for a smartphone and a tablet in any place including high mobility environments such as a train, a vehicle, and an airplane. Other use cases are augmented reality for entertainment and information search. In this case, the augmented reality requires very low latency and instantaneous data volume.

In addition, one of the most expected 5G use cases relates a function capable of smoothly connecting embedded sensors in all fields, i.e., mMTC. It is expected that the number of potential Internet-of-things (IoT) devices will reach 204 hundred million up to the year of 2020. An industrial IoT is one of categories of performing a main role enabling a smart city, asset tracking, smart utility, agriculture, and security infrastructure through 5G.

URLLC includes a new service that will change industry through remote control of main infrastructure and an ultra-reliable/available low-latency link such as a self-driving vehicle. A level of reliability and latency is essential to control a smart grid, automatize industry, achieve robotics, and control and adjust a drone.

5G is a means of providing streaming evaluated as a few hundred megabits per second to gigabits per second and may complement fiber-to-the-home (FTTH) and cable-based broadband (or DOCSIS). Such fast speed is needed to deliver TV in resolution of 4K or more (6K, 8K, and more), as well as virtual reality and augmented reality. Virtual reality (VR) and augmented reality (AR) applications include almost immersive sports games. A specific application program may require a special network configuration. For example, for VR games, gaming companies need to incorporate a core server into an edge network server of a network operator in order to minimize latency.

Automotive is expected to be a new important motivated force in 5G together with many use cases for mobile communication for vehicles. For example, entertainment for passengers requires high simultaneous capacity and mobile broadband with high mobility. This is because future users continue to expect connection of high quality regardless of their locations and speeds. Another use case of an automotive field is an AR dashboard. The AR dashboard causes a driver to identify an object in the dark in addition to an object seen from a front window and displays a distance from the object and a movement of the object by overlapping information talking to the driver. In the future, a wireless module enables communication between vehicles, information exchange between a vehicle and supporting infrastructure, and information exchange between a vehicle and other connected devices (e.g., devices accompanied by a pedestrian). A safety system guides alternative courses of a behavior so that a driver may drive more safely drive, thereby lowering the danger of an accident. The next stage will be a remotely controlled or self-driven vehicle. This requires very high reliability and very fast communication between different self-driven vehicles and between a vehicle and infrastructure. In the future, a self-driven vehicle will perform all driving activities and a driver will focus only upon abnormal traffic that the vehicle cannot identify. Technical requirements of a self-driven vehicle demand ultra-low latency and ultra-high reliability so that traffic safety is increased to a level that cannot be achieved by human being.

A smart city and a smart home/building mentioned as a smart society will be embedded in a high-density wireless sensor network. A distributed network of an intelligent sensor will identify conditions for costs and energy-efficient maintenance of a city or a home. Similar configurations may be performed for respective households. All of temperature sensors, window and heating controllers, burglar alarms, and home appliances are wirelessly connected. Many of these sensors are typically low in data transmission rate, power, and cost. However, real-time HD video may be demanded by a specific type of device to perform monitoring.

Consumption and distribution of energy including heat or gas is distributed at a higher level so that automated control of the distribution sensor network is demanded. The smart grid collects information and connects the sensors to each other using digital information and communication technology so as to act according to the collected information. Since this information may include behaviors of a supply company and a consumer, the smart grid may improve distribution of fuels such as electricity by a method having efficiency, reliability, economic feasibility, production sustainability, and automation. The smart grid may also be regarded as another sensor network having low latency.

Mission critical application (e.g., e-health) is one of 5G use scenarios. A health part contains many application programs capable of enjoying benefit of mobile communication. A communication system may support remote treatment that provides clinical treatment in a faraway place. Remote treatment may aid in reducing a barrier against distance and improve access to medical services that cannot be continuously available in a faraway rural area. Remote treatment is also used to perform important treatment and save lives in an emergency situation. The wireless sensor network based on mobile communication may provide remote monitoring and sensors for parameters such as heart rate and blood pressure.

Wireless and mobile communication gradually becomes important in the field of an industrial application. Wiring is high in installation and maintenance cost. Therefore, a possibility of replacing a cable with reconstructible wireless links is an attractive opportunity in many industrial fields. However, in order to achieve this replacement, it is necessary for wireless connection to be established with latency, reliability, and capacity similar to those of the cable and management of wireless connection needs to be simplified. Low latency and a very low error probability are new requirements when connection to 5G is needed.

Logistics and freight tracking are important use cases for mobile communication that enables inventory and package tracking anywhere using a location-based information system. The use cases of logistics and freight typically demand low data rate but require location information with a wide range and reliability.

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

Here, the radio communication technologies implemented in the wireless devices in the present disclosure may include narrowband internet-of-things (NB-IoT) technology for low-power communication as well as LTE, NR and 6G. For example, NB-IoT technology may be an example of low power wide area network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

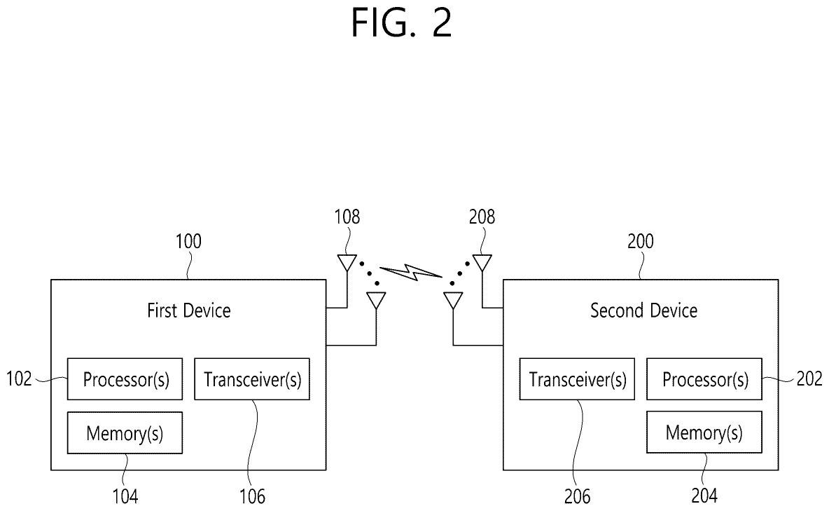

FIG. 2 shows an example of wireless devices to which implementations of the present disclosure is applied.

Referring to FIG. 2, a first wireless device 100 and a second wireless device 200 may transmit/receive radio signals to/from an external device through a variety of RATs (e.g., LTE and NR). In FIG. 2, {the first wireless device 100 and the second wireless device 200} may correspond to at least one of {the wireless device 100a to 100f and the BS 200}, {the wireless device 100a to 100f and the wireless device 100a to ‘} and/or {the BS 200 and the BS 200} of FIG. 1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, suggestions, methods and/or operational flowcharts described in the present disclosure. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver(s) 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, suggestions, methods and/or operational flowcharts described in the present disclosure. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with radio frequency (RF) unit(s). In the present disclosure, the first wireless device 100 may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, suggestions, methods and/or operational flowcharts described in the present disclosure. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, suggestions, methods and/or operational flowcharts described in the present disclosure. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas may be a plurality of physical antennas or a plurality of logical antennas (e.g., antenna ports).

The one or more transceivers 106 and 206 may convert received radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the transceivers 106 and 206 can up-convert OFDM baseband signals to a carrier frequency by their (analog) oscillators and/or filters under the control of the processors 102 and 202 and transmit the up-converted OFDM signals at the carrier frequency. The transceivers 106 and 206 may receive OFDM signals at a carrier frequency and down-convert the OFDM signals into OFDM baseband signals by their (analog) oscillators and/or filters under the control of the transceivers 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

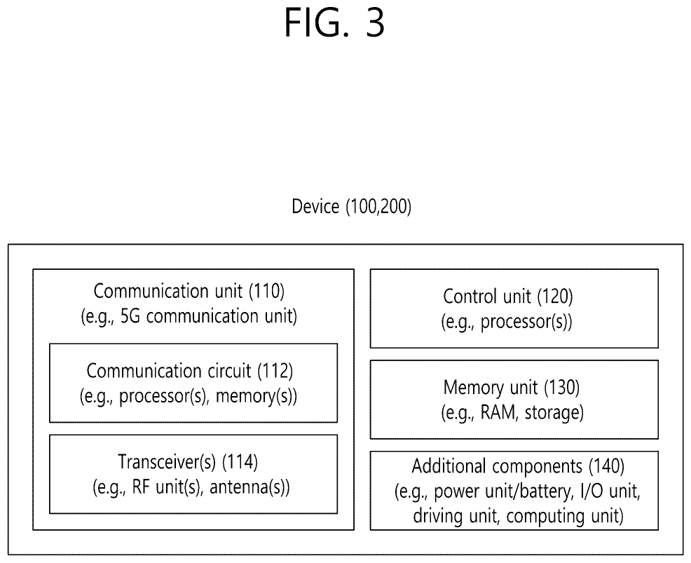

FIG. 3 shows an example of a wireless device to which implementations of the present disclosure is applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory 130 may be configured by a RAM, a DRAM, a ROM, a flash memory, a volatile memory, a non-volatile memory, and/or a combination thereof.

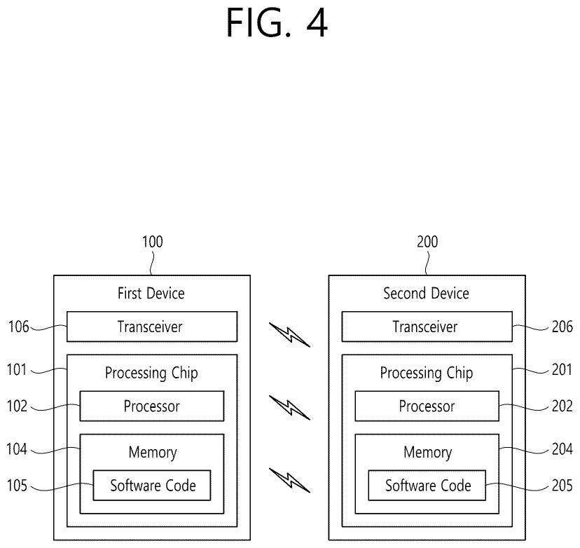

FIG. 4 shows another example of wireless devices to which implementations of the present disclosure is applied.

Referring to FIG. 4, wireless devices 100 and 200 may correspond to the wireless devices 100 and 200 of FIG. 2 and may be configured by various elements, components, units/portions, and/or modules.

The first wireless device 100 may include at least one transceiver, such as a transceiver 106, and at least one processing chip, such as a processing chip 101. The processing chip 101 may include at least one processor, such a processor 102, and at least one memory, such as a memory 104. The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 may perform one or more layers of the radio interface protocol.

The second wireless device 200 may include at least one transceiver, such as a transceiver 206, and at least one processing chip, such as a processing chip 201. The processing chip 201 may include at least one processor, such a processor 202, and at least one memory, such as a memory 204. The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 may perform one or more layers of the radio interface protocol.

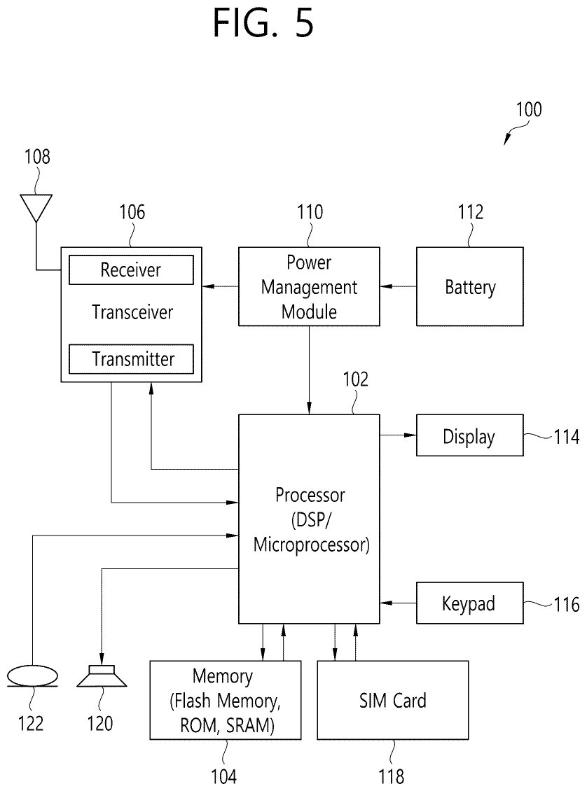

FIG. 5 shows an example of UE to which implementations of the present disclosure is applied.

Referring to FIG. 5, a UE 100 may correspond to the first wireless device 100 of FIG. 2 and/or the first wireless device 100 of FIG. 4.

A UE 100 includes a processor 102, a memory 104, a transceiver 106, one or more antennas 108, a power management module 110, a battery 1112, a display 114, a keypad 116, a subscriber identification module (SIM) card 118, a speaker 120, and a microphone 122.

The processor 102 may be configured to implement the descriptions, functions, procedures, suggestions, methods and/or operational flowcharts disclosed in the present disclosure. The processor 102 may be configured to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of a digital signal processor (DSP), a central processing unit (CPU), a graphics processing unit (GPU), a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 110 manages power for the processor 102 and/or the transceiver 106. The battery 112 supplies power to the power management module 110.

The display 114 outputs results processed by the processor 102. The keypad 116 receives inputs to be used by the processor 102. The keypad 16 may be shown on the display 114.

The SIM card 118 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The speaker 120 outputs sound-related results processed by the processor 102. The microphone 122 receives sound-related inputs to be used by the processor 102.

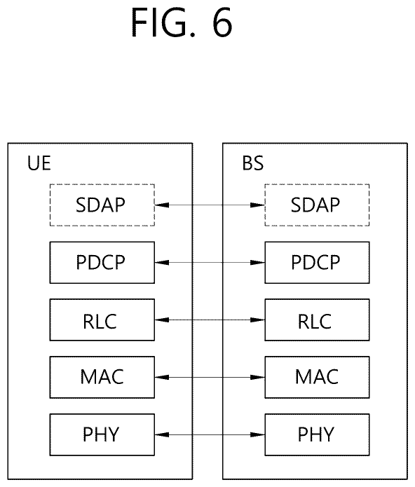

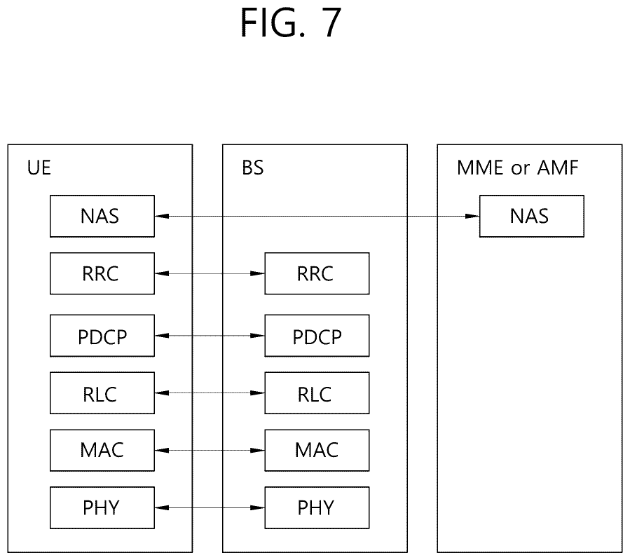

FIGS. 6 and 7 show an example of protocol stacks in a 3GPP based wireless communication system to which implementations of the present disclosure is applied.

In particular, FIG. 6 illustrates an example of a radio interface user plane protocol stack between a UE and a BS and FIG. 7 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 6, the user plane protocol stack may be divided into Layer 1 (i.e., a PHY layer) and Layer 2. Referring to FIG. 7, the control plane protocol stack may be divided into Layer 1 (i.e., a PHY layer), Layer 2, Layer 3 (e.g., an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QOS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

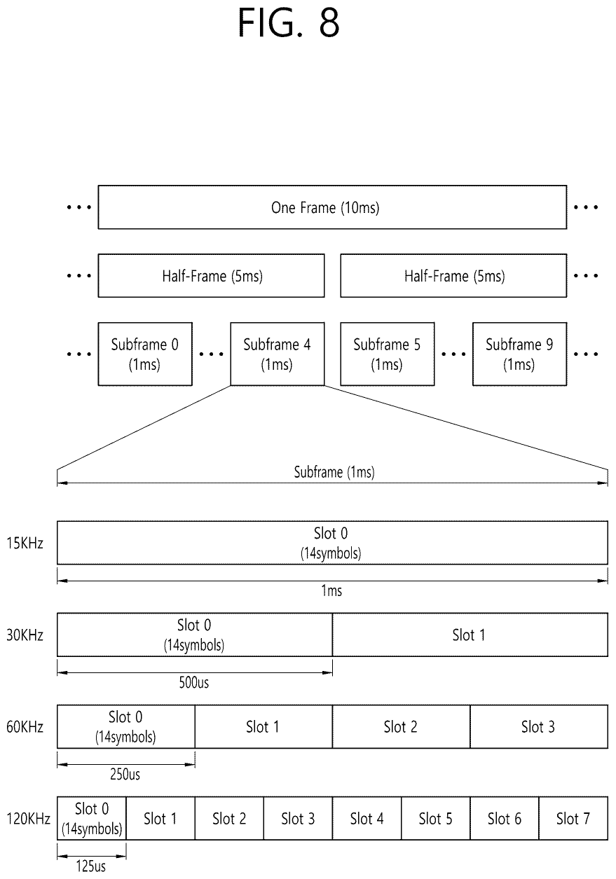

FIG. 8 shows a frame structure in a 3GPP based wireless communication system to which implementations of the present disclosure is applied.

The frame structure shown in FIG. 8 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 8, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing Δf=2^{u}*15 kHz.

Table 1 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing Δf=2^{u}*15 kHz.

TABLE 1

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 2 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing Δf=2^{u}*15 kHz.

TABLE 2

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index l representing a symbol location relative to a reference point in the time domain. In the 3GPP based wireless communication system, an RB is defined by 12 consecutive subcarriers in the frequency domain.

In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

The NR frequency band may be defined as two types of frequency range, i.e., FR1 and FR2. The numerical value of the frequency range may be changed. For example, the frequency ranges of the two types (FR1 and FR2) may be as shown in Table 3 below. For ease of explanation, in the frequency ranges used in the NR system, FR1 may mean “sub 6 GHz range”, FR2 may mean “above 6 GHz range,” and may be referred to as millimeter wave (mmW).

TABLE 3

| Frequency Range | Corresponding frequency | Subcarrier | |
|---|---|---|---|
| designation | range | Spacing | |
| FR1 | 450 MHz-6000 MHz | 15, 30, 60 | kHz |
| FR2 | 24250 MHz-52600 MHZ | 60, 120, 240 | kHz |

As mentioned above, the numerical value of the frequency range of the NR system may be changed. For example, FR1 may include a frequency band of 410 MHz to 7125 MHz as shown in Table 4 below. That is, FR1 may include a frequency band of 6 GHz (or 5850, 5900, 5925 MHz, etc.) or more. For example, a frequency band of 6 GHz (or 5850, 5900, 5925 MHZ, etc.) or more included in FR1 may include an unlicensed band. Unlicensed bands may be used for a variety of purposes, for example for communication for vehicles (e.g., autonomous driving).

TABLE 4

| Frequency Range | Corresponding frequency | Subcarrier | |
|---|---|---|---|
| designation | range | Spacing | |
| FR1 | 410 MHz-7125 MHz | 15, 30, 60 | kHz |
| FR2 | 24250 MHz-52600 MHZ | 60, 120, 240 | kHz |

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

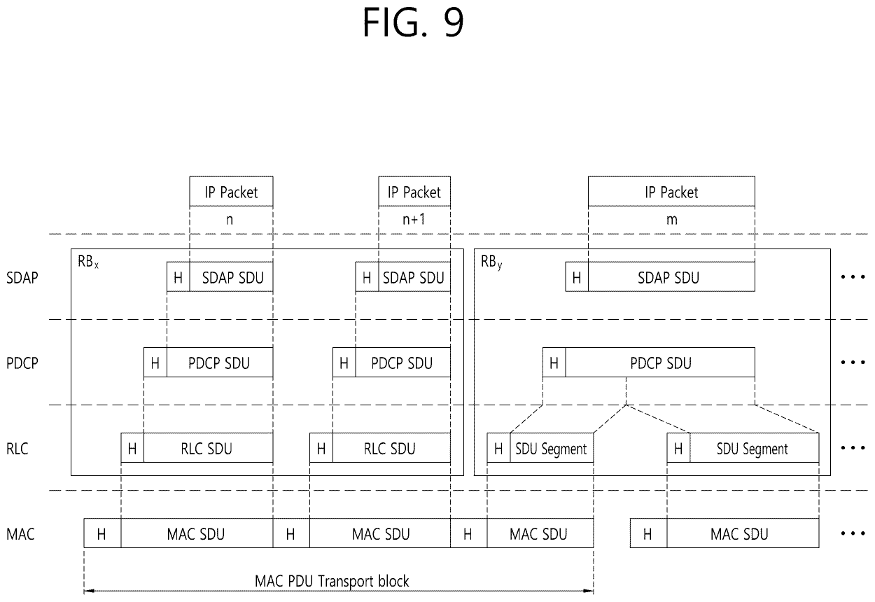

FIG. 9 shows a data flow example in the 3GPP NR system to which implementations of the present disclosure is applied.

Referring to FIG. 9, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to their physical channels PUSCH and PRACH, respectively, and the downlink transport channels DL-SCH, BCH and PCH are mapped to PDSCH, PBCH and PDSCH, respectively. In the PHY layer, uplink control information (UCI) is mapped to PUCCH, and downlink control information (DCI) is mapped to PDCCH. A MAC PDU related to UL-SCH is transmitted by a UE via a PUSCH based on an UL grant, and a MAC PDU related to DL-SCH is transmitted by a BS via a PDSCH based on a DL assignment.

Hereinafter, technical features related to SI change indication and PWS notification are described. Section 5.2.2.2.2 of 3GPP TS 38.331 v16.6.0 may be referred.

A modification period is used, i.e. updated SI message (other than SI message for ETWS, CMAS and positioning assistance data) is broadcasted in the modification period following the one where SI change indication is transmitted. The modification period boundaries are defined by SFN values for which SFN mod m=0, where m is the number of radio frames comprising the modification period. The modification period is configured by system information. The UE receives indications about SI modifications and/or PWS notifications using Short Message transmitted with P-RNTI over DCI. Repetitions of SI change indication may occur within preceding modification period. SI change indication is not applicable for SI messages containing posSIBs.

UEs in RRC_IDLE or in RRC_INACTIVE shall monitor for SI change indication in its own paging occasion every DRX cycle. UEs in RRC_CONNECTED shall monitor for SI change indication in any paging occasion at least once per modification period if the UE is provided with common search space, including pagingSearchSpace, searchSpaceSIB1 and searchSpaceOtherSystemInformation, on the active BWP to monitor paging.

During a modification period where ETWS or CMAS transmission is started or stopped, the SI messages carrying the posSIBs scheduled in posSchedulingInfoList may change, so the UE might not be able to successfully receive those posSIBs in the remainder of the current modification period and next modification period according to the scheduling information received prior to the change.

ETWS or CMAS capable UEs in RRC_IDLE or in RRC_INACTIVE shall monitor for indications about PWS notification in its own paging occasion every DRX cycle. ETWS or CMAS capable UEs in RRC_CONNECTED shall monitor for indication about PWS notification in any paging occasion at least once every defaultPagingCycle if the UE is provided with common search space, including pagingSearchSpace, searchSpaceSIB1 and searchSpaceOtherSystemInformation, on the active BWP to monitor paging.

For Short Message reception in a paging occasion, the UE monitors the PDCCH monitoring occasion(s) for paging.

If the UE receives a Short Message, the UE shall:
1> if the UE is ETWS capable or CMAS capable, the etwsAndCmasIndication bit of Short Message is set, and the UE is provided with searchSpaceSIB1 and searchSpaceOtherSystemInformation on the active BWP or the initial BWP:
2> immediately re-acquire the SIB1;
2> if the UE is ETWS capable and si-SchedulingInfo includes scheduling information for SIB6:
3> acquire SIB6, immediately;
2> if the UE is ETWS capable and si-SchedulingInfo includes scheduling information for SIB7:
3> acquire SIB7, immediately;
2> if the UE is CMAS capable and si-SchedulingInfo includes scheduling information for SIB8:
3> acquire SIB8, immediately;
In case SIB6, SIB7, or SIB8 overlap with a measurement gap it is left to UE implementation how to immediately acquire SIB6, SIB7, or SIB8.
1> if the systemInfoModification bit of Short Message is set:
2> apply the SI acquisition procedure from the start of the next modification period.

Hereinafter, technical features related to acquisition of System Information are described. Section 5.2.2.3 of 3GPP TS 38.331 v16.6.0 may be referred.

### Acquisition of MIB and SIB1

The UE shall:
1> apply the specified BCCH configuration;
1> if the UE is in RRC_IDLE or in RRC_INACTIVE; or
1> if the UE is in RRC_CONNECTED while T311 is running:
2> acquire the MIB, which is scheduled;
2> if the UE is unable to acquire the MIB;
3> perform the actions;
2> else:
3> perform the actions.
1> if the UE is in RRC_CONNECTED with an active BWP with common search space configured by searchSpaceSIB1 and pagingSearchSpace and has received an indication about change of system information; or
1> if the UE is in RRC_CONNECTED with an active BWP with common search space configured by searchSpaceSIB1 and the UE has not stored a valid version of a SIB or posSIB, of one or several required SIB(s) or posSIB(s) and, UE has not acquired SIB1 in current modification period; or
1> if the UE is in RRC_CONNECTED with an active BWP with common search space configured by searchSpaceSIB1, and, the UE has not stored a valid version of a SIB or posSIB, of one or several required SIB(s) or posSIB(s) and, si-BroadcastStatus for the required SIB(s) or posSI-BroadcastStatus for the required posSIB(s) is set to notbroadcasting in acquired SIB1 in current modification period; or
1> if the UE is in RRC_IDLE or in RRC_INACTIVE; or
1> if the UE is in RRC_CONNECTED while T311 is running:
2> if ssb-SubcarrierOffset indicates SIB1 is transmitted in the cell and if SIB1 acquisition is required for the UE:
3> acquire the SIB1, which is scheduled;
3> if the UE is unable to acquire the SIB1:
4> perform the actions related to the essential system information missing;
3> else:
4> upon acquiring SIB1, perform the actions upon reception of the SIB1;
2> else if SIB1 acquisition is required for the UE and ssb-SubcarrierOffset indicates that SIB1 is not scheduled in the cell:
3> perform the actions related to the essential system information missing.

The UE in RRC_CONNECTED is only required to acquire broadcasted SIB1 if the UE can acquire it without disrupting unicast data reception, i.e. the broadcast and unicast beams are quasi co-located.

### Acquisition of an SI Message

For SI message acquisition PDCCH monitoring occasion(s) are determined according to searchSpaceOtherSystemInformation. If searchSpaceOtherSystemInformation is set to zero, PDCCH monitoring occasions for SI message reception in SI-window are same as PDCCH monitoring occasions for SIB1 where the mapping between PDCCH monitoring occasions and SSBs is specified in TS 38.213[13]. If searchSpaceOtherSystemInformation is not set to zero, PDCCH monitoring occasions for SI message are determined based on search space indicated by searchSpaceOtherSystemInformation. PDCCH monitoring occasions for SI message which are not overlapping with UL symbols (determined according to tdd-UL-DL-ConfigurationCommon) are sequentially numbered from one in the SI window. The [x×N+K]^{th} PDCCH monitoring occasion(s) for SI message in SI-window corresponds to the K^{th} transmitted SSB, where x=0, 1, . . . X−1, K=1, 2, . . . N, N is the number of actual transmitted SSBs determined according to ssb-PositionsInBurst in SIB1 and X is equal to CEIL (number of PDCCH monitoring occasions in SI-window/N). The actual transmitted SSBs are sequentially numbered from one in ascending order of their SSB indexes. The UE assumes that, in the SI window, PDCCH for an SI message is transmitted in at least one PDCCH monitoring occasion corresponding to each transmitted SSB and thus the selection of SSB for the reception SI messages is up to UE implementation.

When acquiring an SI message, the UE shall:
1> determine the start of the SI-window for the concerned SI message as follows:
2> if the concerned SI message is configured in the schedulingInfoList:
3> for the concerned SI message, determine the number n which corresponds to the order of entry in the list of SI messages configured by schedulingInfoList in si-SchedulingInfo in SIB1;
3> determine the integer value x=(n−1)×w, where w is the si-WindowLength;
3> the SI-window starts at the slot #a, where a=x mod N, in the radio frame for which SFN mod T=FLOOR(x/N), where Tis the si-Periodicity of the concerned SI message and N is the number of slots in a radio frame;
2> else if the concerned SI message is configured in the posSchedulingInfoList and offsetToSI-Used is not configured:
3> create a concatenated list of SI messages by appending the posSchedulingInfoList in posSI-SchedulingInfo in SIB1 to schedulingInfoList in si-SchedulingInfo in SIB1;
3> for the concerned SI message, determine the number n which corresponds to the order of entry in the concatenated list;
3> determine the integer value x=(n−1)×w, where w is the si-WindowLength;
3> the SI-window starts at the slot #a, where a=x mod N, in the radio frame for which SFN mod T=FLOOR(x/N), where T is the posSI-Periodicity of the concerned SI message and N is the number of slots in a radio frame;
2> else if the concerned SI message is configured by the posSchedulingInfoList and offsetToSI-Used is configured:
3> determine the number m which corresponds to the number of SI messages with an associated si-Periodicity of 8 radio frames (80 ms), configured by schedulingInfoList in SIB1;
3> for the concerned SI message, determine the number n which corresponds to the order of entry in the list of SI messages configured by posSchedulingInfoList in SIB1;
3> determine the integer value x=m×w+ (n−1)×w, where w is the si-WindowLength;
3> the SI-window starts at the slot #a, where a=x mod N, in the radio frame for which SFN mod T=FLOOR(x/N)+8, where T is the posSI-Periodicity of the concerned SI message and N is the number of slots in a radio frame;
1> receive the PDCCH containing the scheduling RNTI, i.e. SI-RNTI in the PDCCH monitoring occasion(s) for SI message acquisition, from the start of the SI-window and continue until the end of the SI-window whose absolute length in time is given by si-WindowLength, or until the SI message was received;
1> if the SI message was not received by the end of the SI-window, repeat reception at the next SI-window occasion for the concerned SI message in the current modification period;

The UE is only required to acquire broadcasted SI message if the UE can acquire it without disrupting unicast data reception, i.e. the broadcast and unicast beams are quasi co-located.

The UE is not required to monitor PDCCH monitoring occasion(s) corresponding to each transmitted SSB in SI-window.

If the concerned SI message was not received in the current modification period, handling of SI message acquisition is left to UE implementation.

A UE in RRC_CONNECTED may stop the PDCCH monitoring during the SI window for the concerned SI message when the requested SIB(s) are acquired.

A UE capable of NR sidelink communication and configured by upper layers to perform NR sidelink communication on a frequency, may acquire SIB12 from a cell other than current serving cell (for RRC_INACTIVE or RRC_IDLE) or current PCell (for RRC_CONNECTED), if SIB12 of current serving cell (for RRC_INACTIVE or RRC_IDLE) or current PCell (for RRC_CONNECTED) does not provide configuration for NR sidelink communication for the frequency, and if the other cell providing configuration for NR sidelink communication for the frequency meets the S-criteria.
1> perform the actions for the acquired SI message.

Hereinafter, technical features related to CSI-RS/TRS are described.

In LTE, the synchronization signal (i.e. PSS/SSS) is transmitted every 10 ms and the CRS is transmitted in almost all subframe, so it is easy for UE to use the synchronization signal or CRS to conduct the time/frequency synchronization, tracking or measurement.

However, in NR, the SSB including SSS for measurement is transmitted every 20 ms and there is no always on reference signal, such as CRS in LTE, so unnecessary wake-up happens frequently and the performance of the time/frequency tracking can be deteriorated, compared to LTE.

The CSI-RS is a reference signal that can be used for CSI estimation, beam management, or time-frequency tracking, and the TRS is a reference signal that can be used to estimate the delay spread and Doppler spread and to improve the performance of the time/frequency tracking.

For UE in RRC_CONNECTED, the CSI-RS/TRS configuration is transmitted via dedicated RRC signal, e.g. RRC Reconfiguraiton.

For UE in RRC_IDLE/INACTIVE, the CSI-RS/TRS configuration is transmitted via system information.

When UE in RRC_IDLE/INACIVE receives the CSI-RS/TRS configuration via system information, the UE consider the CSI-RS/TRS is unavailable until the availability indication for the CSI-RS/TRS indicated in the system information.

The availability indication for CSI-RS/TRS indicates which CSI-RS/TRS is available.

The availability indication for CSI-RS/TRS indicates the available duration.

UE considers the CSI-RS/TRS is available during the available duration.

The availability indication may be transmitted via PEI or paging DCI.

r(m) for CSI-RS is as follow:

$$r ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) )$$

where the pseudo-random sequence c(i) is defined. The pseudo-random sequence generator shall be initialised with

$${c}_{init} = ( {2}^{10} ( {N}_{s y m b}^{slot} {n}_{s , f}^{μ} + l + 1 ) ( 2 {n}_{I D} + 1 ) + {n}_{I D} ) mod {2}^{31}$$

at the start of each OFDM symbol where n^{μ}_{s,f} is the slot number within a radio frame, l is the OFDM symbol number within a slot, and n_{ID} is provided by a higher-layer parameter.

For each CSI-RS configured, the UE shall assume the sequence r(m) being mapped to resources elements (k, l)_{p,μ}. The resource element (k, l)_{p,μ} is within the resource blocks occupied by the CSI-RS resource for which the UE is configured. The time-domain locations of the CSI-RS may be provided by the higher-layer parameters (such as ‘firstOFDMSymbolInTimeDomain’ in below IE) and the frequency-domain location of the CSI-RS may be given by a bitmap provided by the higher-layer parameter (such as ‘frequencyDomainAllocation’ in below IE).

The below ‘IE CSI-RS-ResourceMapping’ may be used to configure the resource element mapping of a CSI-RS resource in time- and frequency domain.

Table 5 shows an example of CSI-RS-ResourceMapping information element.

TABLE 5
-- ASN1START
-- TAG-CSI-RS-RESOURCEMAPPING-START

| | |
|---|---|
| CSI-RS-ResourceMapping ::= | SEQUENCE { |
| frequencyDomainAllocation | CHOICE { |
| row1 | BIT STRING (SIZE (4)), |
| row2 | BIT STRING (SIZE (12)), |
| row4 | BIT STRING (SIZE (3)), |
| other | BIT STRING (SIZE (6)) |

},

| | |
|---|---|
| nrofPorts | ENUMERATED |

{p1,p2,p4,p8,p12,p16,p24,p32},

| | |
|---|---|
| firstOFDMSymbolInTimeDomain | INTEGER (0..13), |
| firstOFDMSymbolInTimeDomain2 | INTEGER (2..12) |

OPTIONAL, -- Need R

| | |
|---|---|
| cdm-Type | ENUMERATED {noCDM, fd-CDM2, |

cdm4-FD2-TD2, cdm8-FD2-TD4},

| | |
|---|---|
| density | CHOICE { |
| dot5 | ENUMERATED {evenPRBs, |

oddPRBs},

| | |
|---|---|
| one | NULL, |
| three | NULL, |
| spare | NULL |

},

| | |
|---|---|
| freqBand | CSI-FrequencyOccupation, |

...
}
-- TAG-CSI-RS-RESOURCEMAPPING-STOP
-- ASN1STOP

### <CSI-RS-ResourceMapping Field Descriptions>

‘cdm-Type’: CDM type.
‘density’: Density of CSI-RS resource measured in RE/port/PRB.
‘freqBand’: Wideband or partial band CSI-RS
‘firstOFDMSymbolInTimeDomain’: Time domain allocation within a physical resource block. The field indicates the first OFDM symbol in the PRB used for CSI-RS.
‘frequencyDomainAllocation’: Frequency domain allocation within a physical resource block. The applicable row number is determined by the frequencyDomainAllocation for rows 1, 2 and 4, and for other rows by matching the values in the column Ports, Density and CDMtype with the values of nrofPorts, cdm-Type and density below.
‘nrofPorts’: Number of ports.

The UE is not expected to receive CSI-RS and DM-RS on the same resource elements.

For channel state estimation purposes, the UE may be configured to measure CSI-RS and estimate the downlink channel state based on the CSI-RS measurements. The UE feeds the estimated channel state back to the gNB to be used in link adaptation.

Meanwhile, if UE receives the system information change indication within a modification period, the UE applies the SI acquisition procedure from the start of the next modification period. The UE applies the previously acquired system information until the UE acquires the new system information.

When UE wakes up to receive the updated system information in the next modification period, the UE can use the CSI-RS/TRS for time/frequency synchronization. However, if the system information which triggers the SI change indication is system information including the CSI-RS/TRS configuration, that is, if the system information including the CSI-RS/TRS configuration is updated, the UE would try to synchronize using the outdated CSI-RS/TRS configuration and may fail to receive the updated system information.

In other words, in NR, synchronization using Channel State Information Reference Signal (CSI-RS) and/or Tracking Reference Signal (TRS) is proposed. For example, CSI-RS/TRS configuration may be included in a specific system information block (SIB).

The SI change indication is not for a certain SIB. The SI change indication may inform that any SIB is changed. That is, it is not possible to know whether the specific SIB including the CSI-RS/TRS configuration is changed only by the SI change indication.

When the SI change indication is for the specific SIB including the CSI-RS/TRS configuration, and when the CSI-RS/TRS configuration is changed, the synchronization failure could occur since the UE could not know the updated CSI-RS/TRS configuration.

Therefore, studies for handling the validity of the CSI-RS/TRS configuration in a wireless communication system are required.

Hereinafter, a method for handling the validity of the CSI-RS/TRS configuration in a wireless communication system, according to some embodiments of the present disclosure, will be described with reference to the following drawings.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings. Herein, a wireless device may be referred to as a user equipment (UE).

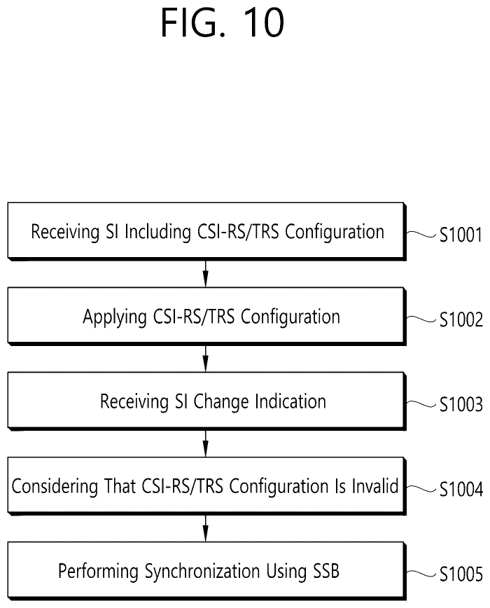

FIG. 10 shows an example of a method for handling the validity of the CSI-RS/TRS configuration in a wireless communication system, according to some embodiments of the present disclosure.

In particular, FIG. 10 shows an example of a method performed by a wireless device in a wireless communication system.

In step S1001, a wireless device may receive system information including a Channel State Information Reference Signal (CSI-RS) and/or Tracking Reference Signal (TRS) configuration.

For example, the wireless device may receive the system information including the CSI-RS and/or TRS configuration before or during a first modification period.

For example, the system information including the CSI-RS and/or TRS configuration may be a System Information Block Type 17 (SIB17).

For example, the wireless device may receive an availability indication for the CSI-RS and/or TRS configuration.

For example, the availability indication may inform which TRS resource set group is available among TRS resource set groups included in the system information and available duration of the available TRS resource set group. For example, the availability indication may be transmitted via a Paging Early Indication (PEI) or a paging DCI, wherein the availability indication is transmitted via a Paging Early Indication (PEI) or a paging DCI.

In step S1002, a wireless device may apply the CSI-RS and/or TRS configuration.

A wireless device may perform time and/or frequency synchronization based on the CSI-RS and/or TRS configuration.

For example, the wireless device may apply the CSI-RS and/or TRS configuration based on receiving the availability indication for the CSI-RS and/or TRS configuration. That is, the wireless device may apply the CSI-RS and/or TRS configuration for synchronization only when the availability indication informs that the CSI-RS and/or TRS configuration is valid.

In step S1003, a wireless device may receive a system information change indication within a first modification period.

For example, the system information change indication may inform whether at least one system information including the system information is to be changed. That is, when the wireless device receives the system information change indication (SI change indication), the wireless device may consider that one or more system information blocks to be changed.

However, the wireless could not know which SIB is to be changed. After receiving a SIB1 in the next modification period (that is, the second modification period in step S1004), the wireless device could know which SIB is to be changed.

In step S1004, a wireless device may consider that the CSI-RS and/or TRS configuration is invalid from a start of a second modification period.

Since there is a chance that the SIB including the CSI-RS and/or TRS configuration (for example, the SIB 17) is to be changed, the wireless device may assume that the CSI-RS and/or TRS configuration is invalid from a start of a second modification period.

The wireless device may consider that the CSI-RS and/or TRS configuration is invalid until it is confirmed from the SIB1 that the SIB including the CSI-RS and/or TRS configuration is not to be changed. For example, the wireless device could confirm that the SIB including the CSI-RS and/or TRS configuration is not to be changed by a value tag for the SIB included in the SIB1.

In step S1005, a wireless device may perform synchronization based on at least one Synchronization Signal and Physical Broadcast CHannel (PBCH) block (SSB).

For example, the wireless device may receive a System Information Block Type 1 (SIB1) after the time and/or frequency synchronization based on the SSB.

For example, the wireless device may wake up at the start of the second modification period by performing synchronization using the SSB, upon receiving the system information change indication (SI change indication).

In other words, the wireless device may determine whether the CSI-RS and/or TRS configuration is valid or not based on the SIB1 informing the system information including the CSI-RS and/or TRS configuration is to be changed.

For example, the SIB1 may include a value tag for the system information including the CSI-RS and/or TRS configuration. The wireless device may determine that the CSI-RS and/or TRS configuration is valid based on the value tag included in the SIB1 being same as a value tag stored in the wireless device.

For example, the wireless device may receive a first SIB 1 including a first value tag for the SIB including the CSI-RS and/or TRS configuration before or during the first modification period and store the first value tag. Then, the wireless device may receive a second SIB 1 including a second value tag for the SIB including the CSI-RS and/or TRS configuration during the second modification period.

If the wireless device determines that the CSI-RS and/or TRS configuration is still valid from the SIB1, the wireless device may apply the CSI-RS and/or TRS configuration. For example, the wireless device may perform synchronization using the CSI-RS and/or TRS configuration until receiving a next SI change indication.

Otherwise, if the wireless device determines that the CSI-RS and/or TRS configuration is not still valid from the SIB1, the wireless device may not use the CSI-RS and/or TRS configuration. For example, the wireless device may perform synchronization using the SSB until receiving another valid CSI-RS and/or TRS configuration.

Here, the second modification period may be a next modification period following the first modification period.

According to some embodiments of the present disclosure, the wireless device may be in communication with at least one of a user equipment, a network, or an autonomous vehicle other than the wireless device.

Hereinafter, technical features related to the validity of the CSI-RS/TRS configuration are described.

### Validity of the CSI-RS/TRS Configuration

If UE receives the system information change indication within N^{th} modification period, the UE may consider the SIB-x (that is, CSI-RS/TRS configuration) is temporarily invalid from the start of N+1^{th} modification period.

The SIB-x may be system information which is used to transmit the CSI-RS/TRS configuration.

After acquiring the SIB1 in the N+1^{th} modification period, the UE may determine whether the CSI-RS/TRS configuration which was valid during the N^{th} modification period is valid in the N+1^{th} modification period, based on the value tag for the SIB-x indicated in the acquired SIB1.

If the value tag is not changed for the SIB-x (i.e. if the value tag of the SIB-x which was valid during the N^{th} modification period is the same as that of the SIB-x indicated in the acquired SIB1), the UE may consider the CSI-RS/TRS configuration which was valid during the N^{th} modification period is valid from the N+1^{th} modification period. If not, the UE may consider it is not valid in the N+1^{th} modification period.

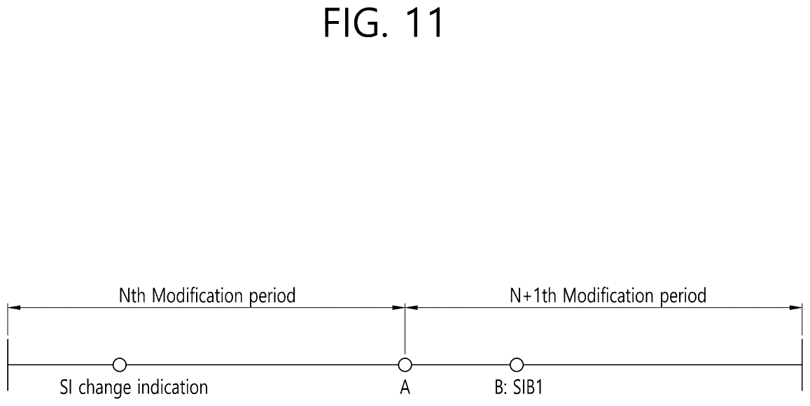

FIG. 11 shows an example of handling the validity of the CSI-RS/TRS configuration.

Referring to FIG. 11, a UE may have a valid SIB-x (i.e. CSI-RS/TRS configuration) and the value tag for the SIB-x may be ‘01010’.

The UE may receive a SI change indication in N^{th} modification period.

The UE may consider the SIB-x with value tag ‘01010’ is not valid from A that is a boundary between two modification periods.

The UE may wake up from the start of the N+1^{th} modification period and use SSB (not CSI-RS/TRS) to synchronize with the serving cell.

The UE may receive SIB1 at B, and check whether the SIB-x is updated (i.e. check whether the value tag for the SIB-x is changed). The value tag indicated in the received SIB1 for the SIB-x may be ‘01010’.

The UE may consider the SIB-x with value tag ‘01010’ is valid from B.

### Applying the CSI-RS/TRS Availability Indication

The CSI-RS/TRS availability indication may indicate which the TRS resource set group is available among the TRS resource set groups configured in the valid SIB-x and its available duration.

For example, the CSI-RS/TRS availability indication can be transmitted via PEI or paging DCI.

For example, UE may apply the CSI-RS/TRS availability indication only to the valid CSI-RS/TRS configuration.

For example, UE may apply the CSI-RS/TRS availability indication only when it has a valid CSI-RS/TRS configuration.

For example, UE can use the CSI-RS/TRS (e.g. for time/frequency synchronization) only when the CSI-RS/TRS configuration is valid and the CSI-RS/TRS is indicated as available by the CSI-RS/TRS availability indication.

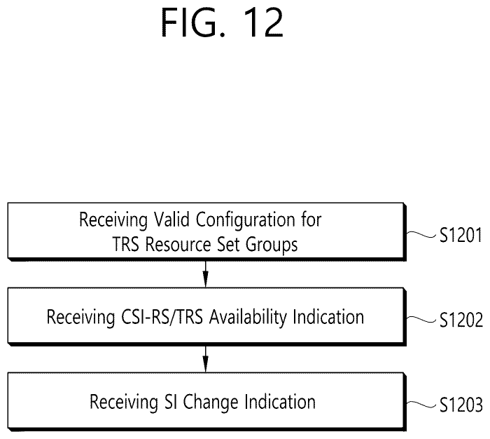

FIG. 12 shows an example of applying the CSI-RS/TRS availability indication.

In step S1201, UE may receive a valid configuration for TRS resource set group #1, #2 and #3, via SIB-x. UE may consider the TRS resource set group #1, #2 and #3 are unavailable.

In step S1202, UE may receive a CSI-RS/TRS availability indication indicating that the TRS resource set group #1 and #2 are available via PEI. UE may consider the TRS resource set group #1 and #2 are available but TRS resource set group #3 is unavailable.

In step S1203, UE may receive the SI change indication within N^{th} modification period. The UE may consider the configuration for the TRS resource set group #1, #2 and #3 is no longer valid from the start of the N+1^{th} modification period.

Since the UE does not have a valid configuration for CSI-RS/TRS, it cannot assume receiving availability indication for CSI-RS/TRS even when PEI which contains availability indication for CSI-RS/TRS is received.

### Validity of the CSI-RS/TRS Availability Indication

If UE receives the system information change indication within N^{th} modification period, the UE may consider all CSI-RS/TRS are expired (i.e. become temporarily unavailable, at the start of N+1^{th} modification period).

If UE receives the system information change indication within N^{th} modification period, the UE may consider the availability timer for all CSI-RS/TRS expires at the start of N+1^{th} modification period.

If UE receives the system information change indication within N^{th} modification period, the UE may ignore the CSI-RS/TRS availability indication from the start of N+1^{th} modification period until acquiring SIB1 in the N+1^{th} modification period.

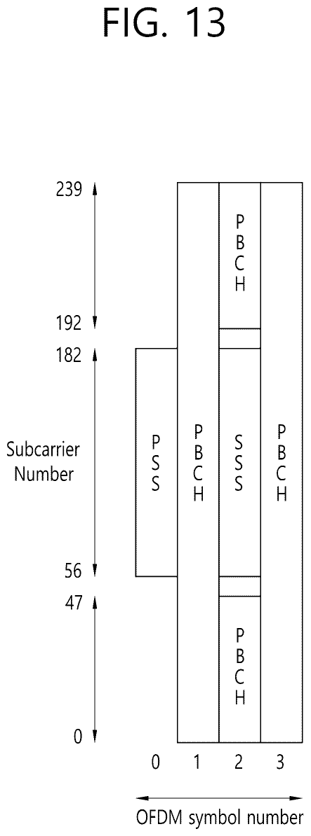

FIG. 13 shows an example of a synchronization signal and PBCH block.

In particular, FIG. 13 shows a Time-frequency structure of the SSB.

The Synchronization Signal and PBCH block (SSB) consists of primary and secondary synchronization signals (PSS, SSS), each occupying 1 symbol and 127 subcarriers, and PBCH spanning across 3 OFDM symbols and 240 subcarriers, but on one symbol leaving an unused part in the middle for SSS as shown in FIG. 13. The possible time locations of SSBs within a half-frame are determined by sub-carrier spacing and the periodicity of the half-frames where SSBs are transmitted is configured by the network. During a half-frame, different SSBs may be transmitted in different spatial directions (i.e. using different beams, spanning the coverage area of a cell).

Within the frequency span of a carrier, multiple SSBs can be transmitted. The PCIs of SSBs transmitted in different frequency locations do not have to be unique, (i.e. different SSBs in the frequency domain can have different PCIs). However, when an SSB is associated with an RMSI, the SSB is referred to as a Cell-Defining SSB (CD-SSB). A PCell is always associated to a CD-SSB located on the synchronization raster.

For example, Polar coding may be used for PBCH.

The UE may assume a band-specific sub-carrier spacing for the SSB unless a network has configured the UE to assume a different sub-carrier spacing.

PBCH symbols carry its own frequency-multiplexed DMRS.

QPSK modulation is used for PBCH.

Table 6 shows an example of a SIB including the TRS configuration.

For example, the SIB including the TRS configuration may be a SIB17. That is, SIB17 contains configurations of TRS resources for idle/inactive UEs.

In particular, Table 6 illustrates an example of the SIB17 information element.

TABLE 6

| | |
|---|---|
| SIB17-r17 ::= | SEQUENCE { |
| segmentNumber-r17 | INTEGER (0..63), |
| segmentType-r17 | ENUMERATED {notLastSegment, lastSegment}, |
| segmentContainer-r17 | OCTET STRING |

}

| | |
|---|---|
| SIB17-IEs-r17 ::= | SEQUENCE { |
| trs-ResourceSetConfig-r17 | SEQUENCE (SIZE (1..maxNrofTRS-ResourceSets- |

r17)) OF TRS-ResourceSet-r17,

| | |
|---|---|
| validityDuration-r17 | ENUMERATED {t1, t2, t4, t8, t16, t32, t64, t128, t256, |

t512, infinity, spare5, spare4, spare3, spare2,

spare1}

OPTIONAL, -- Need S

| | |
|---|---|
| lateNonCriticalExtension | OCTET STRING |

OPTIONAL,
...
}

| | |
|---|---|
| TRS-ResourceSet-r17 ::= | SEQUENCE { |
| powerControlOffsetSS-r17 | ENUMERATED {db−3, db0, db3, db6}, |
| scramblingID-Info-r17 | CHOICE { |
| scramblingIDforCommon-r17 | ScramblingId, |
| scramblingIDperResourceListWith2-r17 | SEQUENCE (SIZE (2)) OF |

ScramblingId,

| | |
|---|---|
| scramblingIDperResourceListWith4-r17 | SEQUENCE (SIZE (4)) OF |

```
ScramblingId,
  ...
  },
```

| | |
|---|---|
| firstOFDMSymbolInTimeDomain-r17 | INTEGER (0..9), |
| startingRB-r17 | INTEGER |

(0..maxNrofPhysicalResourceBlocks−1),

| | |
|---|---|
| nrofRBs-r17 | INTEGER |

(24..maxNrofPhysicalResourceBlocksPlus1),

| | |
|---|---|
| ssb-Index-r17 | SSB-Index, |
| periodicityAndOffset-r17 | CHOICE { |
| slots10 | INTEGER (0..9), |
| slots20 | INTEGER (0..19), |
| slots40 | INTEGER (0..39), |
| slots80 | INTEGER (0..79), |

},

| | |
|---|---|
| frequencyDomainAllocation-r17 | BIT STRING (SIZE (4)), |
| indBitID-r17 | INTEGER (0..5), |
| nrofResources-r17 | ENUMERATED {n2, n4} |

}

SIB17 field descriptions are as below.

segmentContainer: This field includes a segment of the encoded SIB17-IEs. The size of the included segment in this container should be small enough that the SIB message size is less than or equal to the maximum size of a NR SI, i.e. 2976 bits when SIB 17 is broadcast.

segmentNumber: This field identifies the sequence number of a segment of SIB17-IEs. A segment number of zero corresponds to the first segment, a segment number of one corresponds to the second segment, and so on.

segmentType: This field indicates whether the included segment is the last segment or not.

trs-ResourceSetConfig: RS configuration of TRS occasion(s) for idle/inactive UE(s), in terms of a list of N>=1 NZP TRS resource set(s). The maximum number of TRS resource sets configured by higher layer is 64. If a TRS resource is configured, the L1 based availability indication is always enabled based on that configuration. A UE which acquired SIB17 with a TRS configuration but did not yet receive an associated L1-based availability indication considers the configured TRS as unavailable. If SIB scheduling indicates that SIB17 has changed, the UE considers its configured TRS(s) as unavailable until it receives the associated L1-based availability indication(s).

validityDuration: The valid time duration for L1 availability indication, time unit is one default paging cycle. When the field is absent, UE assumes a default time duration to be 2 default paging cycles. The field is only valid while the UE has a valid SIB17.

TRS-ResourceSet field descriptions are as blow.

firstOFDMSymbolInTimeDomain: The index of the first OFDM symbol in the PRB used for TRS in a slot. The field indicates the first symbol in a slot for the first TRS resource within the slot, and the symbol for the second TRS resource in the same slot can be derived implicitly with symbol index as firstOFDMSymbolInTimeDomain+4.

frequencyDomainAllocation: Indicates the offset of the first RE to RE #0 in a RB in row1.

indBitID: The index of the associated bit in TRS availability indication field in DCI. Each TRS resource set is configured with an ID i for the association with (i+1)-th indication bit in TRS availability indication field in DCI.

nrofRBs: Number of PRBs across which corresponding TRS resource spans.

nrofResources: The number of TRS resources for a TRS resource set.

periodicityAndOffset: The periodicity and slot offset (slot) for periodic TRS. It is used to determine the location of the first slot of TRS resource set. The periodicity value slots 10 corresponds to 10 slots, value slots 20 corresponds to 20 slots, and so on.

powerControlOffsetSS: Power offset (dB) of NZP CSI-RS RE to SSS RE.

scramblingID-Info: One or more scrambling IDs are configured for a TRS resource set. If a common scrambling ID is configured, it applies to all the TRS resources within the TRS resource set. Otherwise, each TRS resource within the TRS resource set is provided with a scrambling ID. If the number of TRS resources for the TRS resource set is 2, scramblingIDperResourceListWith2-r17 is configured, while scramblingIDperResourceListWith4-r17 is configured for the case that the number of TRS resources for the TRS resource set is 4.

ssb-Index: The index of reference SSB with which quasi-collocation information is provided.

startingRB: The PRB index where corresponding TRS resource starts in relation to common resource block #0 (CRB #0) on the common resource block grid.

Some of the detailed steps shown in the examples of FIGS. 10, 11, and 12 may not be essential steps and may be omitted. In addition to the steps shown in FIGS. 10, 11, and 12 other steps may be added, and the order of the steps may vary. Some of the above steps may have their own technical meaning.

Hereinafter, an apparatus for handling the validity of the CSI-RS/TRS configuration in a wireless communication system, according to some embodiments of the present disclosure, will be described. Herein, the apparatus may be a wireless device (100 or 200) in FIGS. 2, 3, and 5.

For example, a wireless device may perform methods described above. The detailed description overlapping with the above-described contents could be simplified or omitted.

Referring to FIG. 5, a wireless device 100 may include a processor 102, a memory 104, and a transceiver 106.

According to some embodiments of the present disclosure, the processor 102 may be configured to be coupled operably with the memory 104 and the transceiver 106.

The processor 102 may be adapted to control the transceiver 106 to receive system information including a Channel State Information Reference Signal (CSI-RS) and/or Tracking Reference Signal (TRS) configuration. The processor 102 may be adapted to apply the CSI-RS and/or TRS configuration. The processor 102 may be adapted to control the transceiver 106 to receive a system information change indication within a first modification period. The processor 102 may be adapted to consider that the CSI-RS and/or TRS configuration is invalid from a start of a second modification period. The processor 102 may be adapted to perform synchronization based on at least one Synchronization Signal and PBCH block (SSB).

For example, the processor 102 may be adapted to perform time and/or frequency synchronization based on the CSI-RS and/or TRS configuration.

For example, the processor 102 may be adapted to control the transceiver 106 to receive a System Information Block Type 1 (SIB1) after the time and/or frequency synchronization based on the SSB.

For example, the processor 102 may be adapted to determine whether the CSI-RS and/or TRS configuration is valid or not based on the SIB1 informing the system information including the CSI-RS and/or TRS configuration is to be changed.

For example, the SIB1 may include a value tag for the system information including the CSI-RS and/or TRS configuration.

For example, the processor 102 may be adapted to determine that the CSI-RS and/or TRS configuration is valid based on the value tag included in the SIB1 being same as a value tag stored in the wireless device.

For example, the second modification period may be a next modification period following the first modification period.

For example, the system information change indication may inform whether at least one system information including the system information is to be changed.

For example, the processor 102 may be adapted to control the transceiver 106 to receive an availability indication for the CSI-RS and/or TRS configuration.

For example, the availability indication may inform which TRS resource set group is available among TRS resource set groups included in the system information and available duration of the available TRS resource set group.

For example, the availability indication may be transmitted via a Paging Early Indication (PEI) or a paging DCI.

For example, the availability indication may be transmitted via a Paging Early Indication (PEI) or a paging DCI.

For example, the processor 102 may be adapted to apply the CSI-RS and/or TRS configuration based on receiving the availability indication for the CSI-RS and/or TRS configuration.

For example, the processor 102 may be adapted to control the transceiver 106 to be in communication with at least one of a user equipment, a network, or an autonomous vehicle other than the wireless device.

Hereinafter, a processor for a wireless device for handling the validity of the CSI-RS/TRS configuration in a wireless communication system, according to some embodiments of the present disclosure, will be described.

The processor may be adapted to control the wireless device to receive system information including a Channel State Information Reference Signal (CSI-RS) and/or Tracking Reference Signal (TRS) configuration. The processor may be adapted to control the wireless device to apply the CSI-RS and/or TRS configuration. The processor may be adapted to control the wireless device to receive a system information change indication within a first modification period. The processor may be adapted to control the wireless device to consider that the CSI-RS and/or TRS configuration is invalid from a start of a second modification period. The processor may be adapted to control the wireless device to perform synchronization based on at least one Synchronization Signal and PBCH block (SSB).

For example, the processor may be adapted to control the wireless device to perform time and/or frequency synchronization based on the CSI-RS and/or TRS configuration.

For example, the processor may be adapted to control the wireless device to receive a System Information Block Type 1 (SIB1) after the time and/or frequency synchronization based on the SSB.

For example, the processor may be adapted to control the wireless device to determine whether the CSI-RS and/or TRS configuration is valid or not based on the SIB1 informing the system information including the CSI-RS and/or TRS configuration is to be changed.

For example, the SIB1 may include a value tag for the system information including the CSI-RS and/or TRS configuration.

For example, the processor may be adapted to control the wireless device to determine that the CSI-RS and/or TRS configuration is valid based on the value tag included in the SIB1 being same as a value tag stored in the wireless device.

For example, the second modification period may be a next modification period following the first modification period.

For example, the system information change indication may inform whether at least one system information including the system information is to be changed.

For example, the processor may be adapted to control the wireless device to receive an availability indication for the CSI-RS and/or TRS configuration.

For example, the availability indication may inform which TRS resource set group is available among TRS resource set groups included in the system information and available duration of the available TRS resource set group.

For example, the availability indication may be transmitted via a Paging Early Indication (PEI) or a paging DCI.

For example, the availability indication may be transmitted via a Paging Early Indication (PEI) or a paging DCI.

For example, the processor may be adapted to control the wireless device to apply the CSI-RS and/or TRS configuration based on receiving the availability indication for the CSI-RS and/or TRS configuration.

For example, the processor may be adapted to control the wireless device to be in communication with at least one of a user equipment, a network, or an autonomous vehicle other than the wireless device.

For example, the processor may be configured to control the wireless device to be in communication with at least one of a user equipment, a network, or an autonomous vehicle other than the wireless device.

Hereinafter, a non-transitory computer-readable medium has stored thereon a plurality of instructions for handling the validity of the CSI-RS/TRS configuration in a wireless communication system, according to some embodiments of the present disclosure, will be described.

According to some embodiment of the present disclosure, the technical features of the present disclosure could be embodied directly in hardware, in a software executed by a processor, or in a combination of the two. For example, a method performed by a wireless device in a wireless communication may be implemented in hardware, software, firmware, or any combination thereof. For example, a software may reside in RAM memory, flash memory, ROM memory, EPROM memory, EEPROM memory, registers, hard disk, a removable disk, a CD-ROM, or any other storage medium.

Some example of storage medium is coupled to the processor such that the processor can read information from the storage medium. In the alternative, the storage medium may be integral to the processor. The processor and the storage medium may reside in an ASIC. For another example, the processor and the storage medium may reside as discrete components.

The computer-readable medium may include a tangible and non-transitory computer-readable storage medium.

For example, non-transitory computer-readable media may include random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

According to some embodiment of the present disclosure, a non-transitory computer-readable medium has stored thereon a plurality of instructions. The stored a plurality of instructions may be executed by a processor of a wireless device.

The stored a plurality of instructions may cause the wireless device to receive system information including a Channel State Information Reference Signal (CSI-RS) and/or Tracking Reference Signal (TRS) configuration. The stored a plurality of instructions may cause the wireless device to apply the CSI-RS and/or TRS configuration. The stored a plurality of instructions may cause the wireless device to receive a system information change indication within a first modification period. The stored a plurality of instructions may cause the wireless device to consider that the CSI-RS and/or TRS configuration is invalid from a start of a second modification period. The stored a plurality of instructions may cause the wireless device to perform synchronization based on at least one Synchronization Signal and PBCH block (SSB).

For example, the stored a plurality of instructions may cause the wireless device to perform time and/or frequency synchronization based on the CSI-RS and/or TRS configuration.

For example, the stored a plurality of instructions may cause the wireless device to receive a System Information Block Type 1 (SIB1) after the time and/or frequency synchronization based on the SSB.

For example, the stored a plurality of instructions may cause the wireless device to determine whether the CSI-RS and/or TRS configuration is valid or not based on the SIB1 informing the system information including the CSI-RS and/or TRS configuration is to be changed.

For example, the SIB1 may include a value tag for the system information including the CSI-RS and/or TRS configuration.

For example, the stored a plurality of instructions may cause the wireless device to determine that the CSI-RS and/or TRS configuration is valid based on the value tag included in the SIB1 being same as a value tag stored in the wireless device.

For example, the second modification period may be a next modification period following the first modification period.

For example, the system information change indication may inform whether at least one system information including the system information is to be changed.

For example, the stored a plurality of instructions may cause the wireless device to receive an availability indication for the CSI-RS and/or TRS configuration.

For example, the availability indication may inform which TRS resource set group is available among TRS resource set groups included in the system information and available duration of the available TRS resource set group.

For example, the availability indication may be transmitted via a Paging Early Indication (PEI) or a paging DCI.

For example, the availability indication may be transmitted via a Paging Early Indication (PEI) or a paging DCI.

For example, the stored a plurality of instructions may cause the wireless device to apply the CSI-RS and/or TRS configuration based on receiving the availability indication for the CSI-RS and/or TRS configuration.

For example, the stored a plurality of instructions may cause the wireless device to be in communication with at least one of a user equipment, a network, or an autonomous vehicle other than the wireless device.

For example, the stored a plurality of instructions may cause the wireless device to be in communication with at least one of a user equipment, a network, or an autonomous vehicle other than the wireless device.

Hereinafter, a base station (BS) for handling the validity of the CSI-RS/TRS configuration in a wireless communication system, according to some embodiments of the present disclosure, will be described.

The BS may include a transceiver, a memory, and a processor operatively coupled to the transceiver and the memory.

The processor may be adapted to provide system information including a Channel State Information Reference Signal (CSI-RS) and/or Tracking Reference Signal (TRS) configuration. The processor may be adapted to provide system information change indication within a first modification period. The processor may be adapted to provide a system information block type 1 (SIB 1).

The present disclosure can have various advantageous effects.

According to some embodiments of the present disclosure, a wireless device could efficiently handle the validity of the CSI-RS/TRS configuration.

For example, after receiving the system information change indication, a wireless device can successfully receive the updated system information by stopping using the potentially outdated CSI-RS/TRS configuration.

In other words, for example, upon receiving a system information change indication within a modification period, a wireless device could consider the CSI-RS/TRS configuration is invalid from the start of the next modification period. In this case, the wireless device may not perform the synchronization based on the CSI-RS/TRS configuration during in the next modification period. Thus, the wireless device could avoid to perform the synchronization using the outdated CSI-RS/TRS configuration. In addition, the resources can be saved by preventing synchronization failure using the outdated CSI-RS/TRS configuration.

According to some embodiments of the present disclosure, a wireless communication system could provide an efficient solution for handle the validity of the CSI-RS/TRS configuration.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method performed by a wireless device in a wireless communication system, the method comprising:
receiving system information including a Channel State Information Reference Signal (CSI-RS) and/or Tracking Reference Signal (TRS) configuration;
applying the CSI-RS and/or TRS configuration;
receiving a system information change indication within a first modification period;
considering that the CSI-RS and/or TRS configuration is invalid from a start of a second modification period; and
performing synchronization based on at least one Synchronization Signal and Physical Broadcast CHannel (PBCH) block (SSB).

2. The method of claim 1, wherein the method further comprises,
performing time and/or frequency synchronization based on the CSI-RS and/or TRS configuration.

3. The method of claim 1, wherein the method further comprises,
receiving a System Information Block Type 1 (SIB1) after the time and/or frequency synchronization based on the SSB.

4. The method of claim 3, wherein the method further comprises,
determining whether the CSI-RS and/or TRS configuration is valid or not based on the SIB1 informing the system information including the CSI-RS and/or TRS configuration is to be changed.

5. The method of claim 3,
wherein the SIB1 includes a value tag for the system information including the CSI-RS and/or TRS configuration.

6. The method of claim 5, wherein the method further comprises,
determining that the CSI-RS and/or TRS configuration is valid based on the value tag included in the SIB1 being same as a value tag stored in the wireless device.

7. The method of claim 1,
wherein the second modification period is a next modification period following the first modification period.

8. The method of claim 1,
wherein the system information change indication informs whether at least one system information including the system information is to be changed.

9. The method of claim 1, wherein the method further comprises,
receiving an availability indication for the CSI-RS and/or TRS configuration.

10. The method of claim 9,
wherein the availability indication informs which TRS resource set group is available among TRS resource set groups included in the system information and available duration of the available TRS resource set group.

11. The method of claim 9,
wherein the availability indication is transmitted via a Paging Early Indication (PEI) or a paging DCI.

12. (canceled)

13. The method of claim 9, wherein the method further comprises,
applying the CSI-RS and/or TRS configuration based on receiving the availability indication for the CSI-RS and/or TRS configuration.

14. The method of claim 1,
wherein the wireless device is in communication with at least one of a user equipment, a network, or an autonomous vehicle other than the wireless device.

15. A wireless device in a wireless communication system comprising:
a transceiver;
a memory; and
at least one processor operatively coupled to the transceiver and the memory, and adapted to:
receive system information including a Channel State Information Reference Signal (CSI-RS) and/or Tracking Reference Signal (TRS) configuration;
apply the CSI-RS and/or TRS configuration;
receive a system information change indication within a first modification period;
consider that the CSI-RS and/or TRS configuration is invalid from a start of a second modification period; and
perform synchronization based on at least one Synchronization Signal and PBCH block (SSB).

16. The wireless device of claim 15, wherein the at least one processor is further adapted to,
perform time and/or frequency synchronization based on the CSI-RS and/or TRS configuration.

17. The wireless device of claim 15, wherein the at least one processor is further adapted to,
receive a System Information Block Type 1 (SIB1) after the time and/or frequency synchronization based on the SSB.

18. The wireless device of claim 17, wherein the at least one processor is further adapted to,
determine whether the CSI-RS and/or TRS configuration is valid or not based on the SIB1 informing the system information including the CSI-RS and/or TRS configuration is to be changed.

19. The wireless device of claim 17,
wherein the SIB1 includes a value tag for the system information including the CSI-RS and/or TRS configuration.

20. The wireless device of claim 19, wherein the at least one processor is further adapted to,
determine that the CSI-RS and/or TRS configuration is valid based on the value tag included in the SIB1 being same as a value tag stored in the wireless device.

21-31. (canceled)

32. A base station in a wireless communication system comprising:
a transceiver;
a memory; and
a processor operatively coupled to the transceiver and the memory, and adapted to:
provide system information including a Channel State Information Reference Signal (CSI-RS) and/or Tracking Reference Signal (TRS) configuration;
provide system information change indication within a first modification period; and
provide a system information block type 1 (SIB 1).
